(19) United States
(12) Patent Application Publication
(10) Pub. No.: US 2025/0085306 A1
(43) Pub. Date: Mar. 13, 2025

(54) SAMPLE DEPOSITION FOR IMAGING

(71) Applicant: The University of North Carolina at Chapel Hill, Chapel Hill, NC (US)

(72) Inventors: Dorothy Erie, Chapel Hill, NC (US); Emily Lentz, Chapel Hill, NC (US)

(21) Appl. No.: 18/883,180

(22) Filed: Sep. 12, 2024

Related U.S. Application Data
(60) Provisional application No. 63/537,971, filed on Sep. 12, 2023.

(51) Int. Cl. G01N 35/10; G01N 35/00

(52) U.S. Cl. CPC G01N 35/1074; G01N 35/0099; G01N 35/1002; G01N 2035/00158

(57) ABSTRACT

A stamp-transfer method for deposition of DNA, protein-DNA complexes, other polymers, and other biomolecules for scanning probe microscopy, including atomic force microscopy (AFM) as well as other imaging techniques. The method is suitable for adaptation to high-throughput depositions and can improve image resolution of the conformational states of protein-DNA complexes.

### GOVERNMENT INTEREST

This invention was made with government support under Grant No. GM127151 awarded by the National Institutes of Health. The government has certain rights in the invention.

### TECHNICAL FIELD

The subject matter disclosed herein relates to a stamp-transfer method for deposition of DNA, protein-DNA complexes, other biomolecules and polymers for scanning probe microscopy (SPM), including atomic force microscopy (AFM), as well as for other imaging techniques. This method is suitable for adaptation to high-throughput depositions and can improve image resolution of the conformational states of protein-DNA complexes.

### BACKGROUND

Atomic force microscopy (AFM) provides a topographic image of a surface, and it is a powerful technique to characterize the structural/conformational properties and assembly states of proteins, DNA, and protein-DNA complexes. As a surface analysis technique, AFM requires a sample to be deposited on a suitable solid surface for imaging. A key requirement of the surface is that it be flat relative to the object being imaged, and glass, silicon, gold, and mica, which is a bilayer aluminosilicate mineral (most common when high height resolution is needed) are examples of such surfaces. Mica is a preferred surface for protein and DNA samples, as well as other soft materials such as polymers, because it is easy to prepare an atomically flat surface. Mica can be split into thin, atomically flat (negatively-charged) sheets (1) with mean surface roughness of 0.05 nm compared to ˜0.5 nm of optimally prepared glass substrates (2, 3). For AFM depositions, a piece of scotch tape is used to peel the top layer of mica, thereby revealing a clean, smooth, negatively-charged, hydrophilic surface ready for use (4). Typically, several microliters (5-40 μL) of the sample are dropped onto a mica surface, allowed to spread, rinsed with water, and dried with N₂ (5-9). Proteins and neutral or positively-charged molecules generally adhere well to the mica surface; however, negatively-charged DNA does not readily adhere to mica in the absence of divalent cations or in higher monovalent salt concentrations. As such, for deposition of DNA in physiological ionic strength, the mica surface is generally modified to render it positively charged. (5, 10, 11). These modifications both roughen the surface and change it from superhydrophilic to hydrophobic, which dramatically slows sample spreading. This slower spreading can cause non-uniform coverage, with higher coverage at the center of the drop. These properties increase the probability of the surface altering the conformations of or interactions between molecules.

Deposition of complexes remains a significant bottleneck in efficiently collecting AFM (and other SPM) data. There is great need for a robust deposition method that is compatible with a wide variety of biological samples, reproducible, permits a wide range of concentrations of macromolecules, and can be automated. Such a development would allow multiple experimental conditions in a single deposition and could revolutionize AFM imaging by making it “high-throughput.”

### SUMMARY

In accordance with this disclosure, this disclosure relates to a stamp-transfer deposition method to immobilize one or more biomolecules and/or polymers on a surface of a substrate. The method is particularly useful for substrates suitable for scanning probe microscopy (SPM) but can be used with other techniques requiring surface deposition. In some embodiments, this method comprises (a) dispensing a liquid sample comprising one or more biomolecule and/or polymer into at least one microwell present on a wafer to form a thin liquid layer; (b) contacting the liquid layer in the at least one microwell with the surface of the substrate for a time sufficient to transfer a portion of the sample to the surface such that biomolecule and/or polymer adheres to the surface; (c) removing the surface from contact with the liquid layer with the biomolecule and/or polymer being immobilized on the surface of the substrate, and (d) optionally, drying, or rinsing and drying, the substrate. Such substrates can then be further prepared for SPM or other technique as needed.

The methods, apparatus or systems hereof are applicable to imaging for any form of SPM and many variations of SPM are well known in the art. Exemplary forms of SPM include, but are not limited to, atomic force microscopy (AFM), scanning tunneling microscopy (STM), near-field scanning optical microscopy (SNOM/NSOM), scanning electron microscopy and electrochemical AFM. In some embodiments, AFM, or electron microscopy, is preferred.

In any of the embodiments of any of the methods, apparatus or systems hereof, the biomolecule(s) and/or polymer(s) can comprise nucleic acids, proteins, protein-nucleic acid complexes, carbohydrates, polysaccharides, cellulose, syntheticpolymers (such as PEG, PLA, homoamino acid polymers), cells, subcellular organelles, bacteria, viruses or other biological material. In some embodiments, the nucleic acids include, but are not limited to, DNA, RNA or modified nucleic acids.

In any of the embodiments of any of the methods, apparatus or systems hereof, the liquid sample comprises physiological or higher salt.

In any of the embodiments of any of the methods, apparatus or systems hereof, the wafer comprises a plurality of microwells, which can be arranged in any array format and which wells are sufficiently separate from each other to avoid sample bleed over upon removal of the surface from contact with the liquid layer.

In any of the embodiments of any of the methods, apparatus or systems hereof, the sample in each of the plurality of microwells is independently the same (identical) or different.

In any of the embodiments of any of the methods, apparatus or systems hereof, dispensing is performed by an inkjet-type device or by a microfluidic device. Samples can be dispensed manually.

In any of the embodiments of any of the methods, apparatus or systems hereof, the wafer is a semiconductor wafer or other silicon-based wafer and can be used with or without a coating. In some embodiments, the wafer is a silicon nitride wafer. In any of the embodiments, the wafer has a silicon oxide coating.

In any of the embodiments of any of the methods, apparatus or systems hereof, the wafer comprises one or more microwells, and in other embodiments, a plurality of microwells. In some embodiments, the microwells are or have been etched into the wafer.

In any of the embodiments of any of the methods, apparatus or systems hereof, the substrate onto which the biomolecules and/or polymers will be transferred comprises a smooth flat surface, and preferably a substrate suitable for SPM. The substrate can include, but is not limited to, mica, gold, glass, quartz, graphite, silicon or any suitable plastic material, or any combination(s) thereof. In some embodiments the surface is treated; in some embodiments the surface is untreated. In some embodiments, the substrate is untreated mica.

In any of the embodiments of any of the methods, apparatus or systems hereof, the substrate has a removable, flexible backing. In some embodiments, the backing comprises polydimethylsiloxane (PDMS).

In any of the embodiments of any of the methods, apparatus or systems hereof, the substrate can be dried after removing the surface from contact with the liquid layer. Alternatively, the substrate can be rinsed with water or an appropriate buffer or solution before or after drying, without significant loss of the immobilized biomolecules and/or polymers from the surface of the substrate.

In a further aspect, this disclosure provides a high-throughput method for depositing biomolecules and/or polymers on a surface of a single substrate for imaging via scanning probe microscopy or other technique which comprises (a) robotically dispensing a liquid sample comprising biomolecules and/or polymers into a plurality of microwells on a wafer to form a thin liquid layer in each microwell; (b) simultaneously contacting each liquid layer in the plurality of microwells with the surface of the single substrate for a time sufficient to transfer a portion of each sample to the surface of the substrate such that biomolecules and/or polymers adhere to the surface; (c) removing the surface from contact with each liquid layer with the biomolecules and/or polymers being immobilized on the surface of the substrate; and (d) optionally, drying, or rinsing and drying, the substrate in preparation for imaging.

Various embodiments for use in this method are summarized above.

In a further aspect, this disclosure provides a stamp transfer apparatus comprising (a) a base to support a wafer comprising one or more microwells; (b) an upper piston that can be moved back and forth in a vertical direction relative to the base and which comprises a headpiece attached to the piston and positioned above the base and is capable of being lowered to the base to contact a wafer on the base; (c) a headpiece for releasably holding an imaging substrate, and its optional backing, on the underside of the headpiece; and (d) a control mechanism to move the piston and bring the imaging substrate into and out of contact with the wafer. In some embodiments, the substrate is held on the underside of the headpiece by applying a vacuum through a port on the headpiece. The stamp transfer apparatus could be an automated stamp transfer apparatus.

Various embodiments for elements of this apparatus are summarized above.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting examples.

FIG. 1A illustrates a microwell array etched on Si wafer with ˜300 nm coating of SiO₂. FIG. 1B illustrates a representative SEM image of microwell cross section.

FIG. 2A is a schematic view illustrating an example stamp transfer apparatus for performing depositions, either singly or high throughput.

FIG. 2B is an isometric view of an example adapter piece for the sampling apparatus.

FIG. 3 illustrates example steps for traditional drop deposition method (left side) versus stamp-transfer deposition (right side).

FIGS. 4A, 4B, 4C, 4D, 4E, and 4F show AFM images of 2,708 base pair linear DNA deposited in different conditions and DNA end-to-end distance.

FIGS. 5A, 5B, and 5C are graphs with MutS showing high specificity for a T-bulge under all deposition conditions.

FIGS. 6A, 6B, 6C, and 6D show histograms of DNA bend angles induced by Thermus aquaticus (T. aquaticus) MutS bound to the T-bulge site and representative AFM images.

FIGS. 7A and 7B illustrate RNA polymerase induced DNA bending at the AmpR site for different deposition methods.

FIGS. 8A, 8B, and 8C illustrate multi-transfer deposition of circular T-bulge DNA and T. aquaticus MutS in the presence and absence of ATP.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of time, temperature, weight, concentration, volume, strength, speed, length, width, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example +0.1% from the specified amount, as such variations are appropriate to perform the disclosed methods.

Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, the term “nucleic acid molecule” is intended to include DNA molecules, RNA molecules (e.g., mRNA, shRNA, siRNA, microRNA), analogs of the DNA or RNA generated using nucleotide analogs, and derivatives, fragments and homologs thereof. The nucleic acid molecules of the invention may be single-, double-, or triple-stranded. A nucleic acid molecule of the present invention may be isolated using sequence information provided herein and well known molecular biological techniques (e.g., as described in Sambrook et al., Eds., MOLECULAR CLONING: A LABORATORY MANUAL 2ND ED., Cold Spring Harbor Laboratory Press, Cold Spring Harbor, N.Y., 1989; and Ausubel, et al., Eds., CURRENT PROTOCOLS IN MOLECULAR BIOLOGY, John Wiley & Sons, New York, N.Y., 1993).

The term “oligonucleotide” as used herein refers to a series of covalently linked nucleotide (or nucleoside residues, including ribonucleoside or deoxyribonucleoside residues) wherein the oligonucleotide has a sufficient number of nucleotide bases to be used in a PCR reaction. Oligonucleotides comprise portions of a nucleic acid sequence having at least about 10 nucleotides and as many as 50 nucleotides, preferably about 15 nucleotides to 30 nucleotides. Oligonucleotides may be chemically synthesized and may be used as probes.

### General Considerations

The present disclosure preparing samples for imaging by scanning probe microscopy as well as other imaging or microscopy techniques. This disclosure thus provides methods for deposition of samples onto a surface via a stamp-transfer process and systems for making such methods amenable to high throughput processing comprising a robot interfaced to a microfluidics device (e.g., in the picoliter range) or inkjet printer head (12, 13) for picking up and dispensing samples into an array of microwells etched into silicon or other wafer or chip material, an automated vertical press to bring the microwells containing a liquid sample into contact with the sample surface (mica, in the examples described below). As exemplified herein, a manual stamp-transfer apparatus deposited DNA and protein-DNA complexes onto bare mica in physiological salt concentrations. Any suitable automated stamp transfer apparatus could be utilized also in accordance with the disclosure herein. Various materials can be used for the microwells with silicon and silicon/silicon dioxide wafers working well for these DNA and protein-DNA transfers. In the exemplified stamp-transfer process, a soft, flexible backing was used allowing soft contact of the mica with the microwell-filled samples and minimizing potential damage of the mica surface. Because mica is extremely hydrophilic (14), the sample readily transferred from the fabricated chip to the mica upon contact. After transfer, the mica surface was rinsed, residual liquid removed using N₂, and the sample imaged by AFM.

The methods disclosed herein allowed comparison of the conformational properties of DNA and protein-DNA complexes deposited using a traditional method versus the present stamp-transfer method. Finally, the stamp-transfer method exemplified herein allowed multiple different samples to be deposited simultaneously on a single mica sheet without contamination between samples.

### Deposition Methods

In one aspect, this disclosure relates to stamp-transfer deposition methods to immobilize biomolecules and/or polymers on a surface of a substrate, preferably substrates suitable for imaging by scanning probe microscopy (SPM) or electron microscopy. The method is applicable with any form of surface imaging in which the molecule or particle for examination is deposited on a surface and is adaptable for high throughput use and applications. The method has been found useful with molecules or particles under a variety of conditions that could not be previously compared on the same substrate. For example, DNA sticks to untreated mica when present in low salt in the presence of divalent ions but not under high salt conditions or physiological conditions due to the negative charges of both DNA and mica. The present deposition methods overcome such limitations and others.

In an embodiment of the disclosure, the method provides for dispensing a liquid sample comprising biomolecules and/or polymers into one or more microwells present on a wafer to form a thin liquid layer; contacting the liquid layer in the microwells with the surface of the substrate for a time sufficient to transfer a portion of the sample to the surface such that biomolecules and/or polymers adhere to the surface; removing the surface from contact with the liquid layer in the microwells with the biomolecules and/or polymers being immobilized on the surface of the substrate; and drying the substrate where the biomolecules and/or polymers are immobilized in the sample onto the surface of the substrate. In some embodiments, the surface of the substrate can be rinsed after removing the substrate from contact with the liquid layer but prior to drying.

In embodiments of any of the methods and uses described herein, scanning probe microscopy includes, but is not limited to, atomic force microscopy (AFM), scanning tunneling microscopy (STM), near-field scanning optical microscopy (SNOM/NSOM), scanning electron microscopy or electrochemical AFM. SPM imaging methods are well known in the art and this method is applicable to any and all forms and variations of SPM. In some embodiment, the method is used to prepare samples for AFM imaging.

In embodiments of any of the methods and uses described herein, “biomolecules and/or polymers” as defined and used herein include, but are not limited to, nucleic acids, proteins, protein-nucleic acid complexes, carbohydrates, polysaccharides, cellulose, synthetic polymers (such as PEG, PLA, PLGA, homoamino acid polymers, e.g., poly-L-lysine, and the like), cells, subcellular organelles, bacteria, viruses or other biological material. In any of the embodiments, the nucleic acids are DNA, RNA or modified nucleic acids. In some embodiments the nucleic acids are oligonucleotides. In some embodiments, the proteins are peptides.

The substrates for use in the methods comprise any material suitable for scanning probe microscopy or other imaging technique. The substrates have a smooth flat surface upon which the sample is deposited for analysis, e.g., by SPM. Such substrates include but are not limited to, mica, gold, glass, quartz, graphite, silicon, or any suitable plastic material, or any combination(s) thereof, whether treated or untreated. For example, a substrate can be chemically treated to change surface charge or to provide covalent or non-covalent interaction with the biomolecules and/or polymers being deposited.

Substrates can be formed in thin sheets with or without a backing material as needed for support, softness or flexibility. The backings are optionally removable from the substrates. For example, in some embodiments, the backing material comprises polydimethylsiloxane (PDMS), Viton (Dupont) or synthetic rubber. Such materials may have a durometer range of from about 25 to about 90.

Those of skill in the art can select the appropriate substrate based on the biomolecules and/or polymers to be deposited on the surface of the substrate. In embodiments suitable for nucleic acids and protein-nucleic acid complexes, the substrate is mica, and is preferably untreated mica, particularly because it has been demonstrated that such molecules adhere under physiological salt conditions—which has heretofore not been achievable at a density sufficient for imaging by AFM or other scanning probe microscopy technique.

Treating the surface of a substrate can be done to modify the surface charge or allow covalent attachment of the biomolecule and/or polymer for imaging. Types of treatments and methods for treating the surface of a substrate are known in the art.

In accordance with the methods hereof, biomolecules and/or polymers are present in a liquid sample under the desired solution conditions. Typically, for many biomolecules and/or polymers, especially biological materials, such liquids are aqueous solutions which contain salts, buffers or reactants to maintain the material in a desired state or under desired reaction conditions. For some biomolecules and/or polymers, such as synthetic polymers like PEG, or polysaccharides, the liquid can be a solvent known to dissolve such polymers or to maintain such polymers in a desired configuration or conformation and may be a non-aqueous liquid.

As used herein, a “wafer” (or “chip” which terms are used interchangeably) is any thin material in which microwells can be formed and includes, but is not limited to, semiconductor wafers, including wafers made from silicon, silicon nitride, or other materials. Any of the wafers can have a coating, including silicon oxide or gold coatings. In some embodiments, the wafers are silicon with a silicon coated with a layer of silicon dioxide.

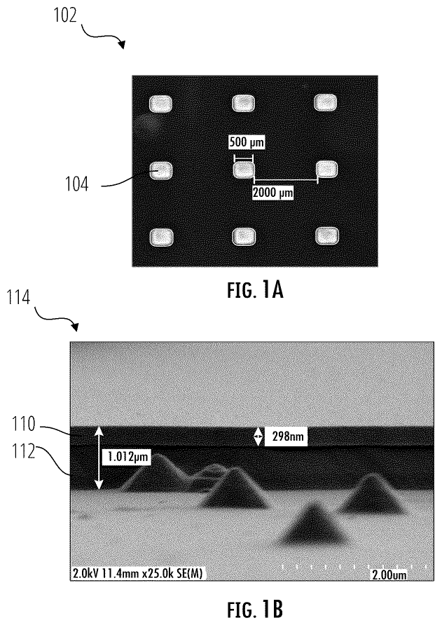

The microwells in the wafer are generally preferred to be shallow (in the z dimension) relative to the x-y dimensions of the microwell(s) present in the plane of the wafer. However, any particular depth can be made for convenience and simplicity of the stamp transfer. The overall x-y dimension of the microwell provides an area in which a thin liquid layer forms based on the volume of sample dispensed into the microwell. For example, the wafers and microwells can be compatible with and/or designed for microfluidics. Volumes used in microfluidics range from femtoliters to nanoliters. In an embodiment, for example, a microwell array is etched on a Si wafer with ˜300 nm coating of SiO₂ with microwells that are 500 μm×500 μm squares spaced 2000 μm apart in a rectangular array. A well depth of ˜1 μm is convenient. This configuration is illustrated in FIG. 1A and FIG. 1B, which are described in more detail below with respect to Microwell Characterization.

When used, a plurality of microwells can be formed on the wafer in any convenient configuration, provided the microwells are sufficiently separate from each other to avoid sample bleed over upon removal of the surface from contact with the liquid layer. Microwell fabrication methods are known in the art and include, but are not limited to, etching such as deep reactive ion etching (DRIE).

In accordance with the methods hereof, the liquid sample can be dispensed into the microwell(s) manually or via an automated computer-controlled system. Automated systems using an inkjet-type head or a microfluidics device enable high-throughput dispensing of multiple liquid samples simultaneously and, thus, for working in microfluidics volume ranges. The liquid samples so dispensed may be independently the same (identical) or different.

In accordance with the methods hereof, the liquid layer in the microwell(s) is contacted with the surface of the substrate for a time sufficient to transfer a portion of the sample to the surface of the substrate. Contacting is done by gently lowering the substrate to the wafer until the surface of the substrate touches the liquid layer (i.e., a stamping-type motion) sufficiently to transfer at least a portion of the liquid to the substrate. Contacting can be done manually or robotically using computer control to lower the piston of the apparatus to the substrate. The actual contact time may only be 1-2 seconds or less and transfer is readily observable. Once the contact and transfer are completed, the substrate is prepared for imaging. For example, based on the biomolecules and/or polymers and substrate, the substrate may optionally be rinsed and then dried and stored until imaging. Drying can be done in air or with an inert gas (e.g., N₂) under conditions which maintain cleanliness.

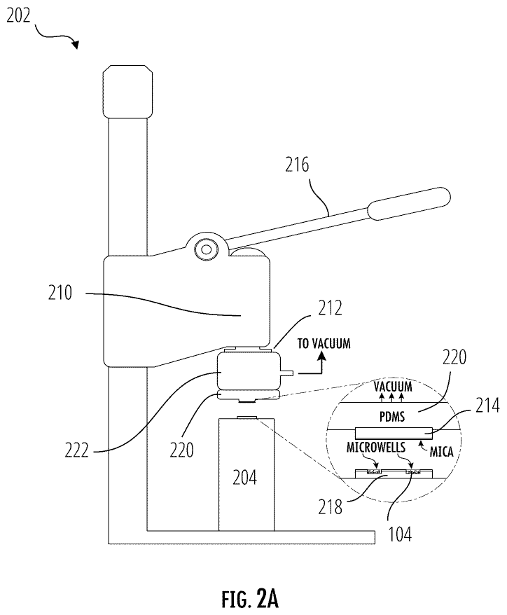

The apparatus shown in FIGS. 2A and 2B (and fully described in the Examples) provides a convenient device for performing the contacting step. Such a device is adaptable by those of skill in the art for high throughput use and for computer processor control to perform the methods of the disclosure.

In some of the embodiments of the disclosure for high-throughput depositing of biomolecules and/or polymers, the method comprises (a) robotically dispensing a liquid sample comprising biomolecules and/or polymers into a plurality of microwells on a wafer to form a thin liquid layer in each microwell, (b) simultaneously contacting each liquid layer in the plurality of microwells with the surface of a single substrate for a time sufficient to transfer a portion of each sample to the surface of the substrate such that biomolecules and/or polymers adhere to the surface; (c) removing the surface from contact with the liquid layers with the biomolecules and/or polymers adhered to the surface; and (d) drying the substrate where the biomolecules and/or polymers are immobilized on the surface of the substrate. The substrate may be optionally rinsed before drying.

The substrate, liquid samples, and other elements of such high-throughput methods for depositing biomolecules and/or polymers as well as the steps are as described herein.

### Stamp Transfer Apparatus

FIG. 2A is a schematic view illustrating an example stamp transfer apparatus 202 for performing depositions, either singly or high throughput. As noted previously, any suitable automated stamp transfer apparatus could be utilized in accordance with the disclosure herein. This apparatus shows an exemplary apparatus 202 for performing the stamp-transfer methods of the disclosure. In an embodiment of the disclosure, a stamp transfer apparatus 202 includes a base 204 to support a wafer 218 comprising one or more microwells 104. The stamp transfer apparatus 202 includes an upper piston 210 that can be moved vertically relative to the base 204 and which comprises a headpiece 212 positioned above the base 204 and capable of being lowered to the base 204 to contact a wafer 218 on the base 204. The headpiece 212 is for releasably holding an imaging substrate 214, and its optional backing 220, on the underside of the headpiece 212.

The stamp transfer apparatus 202 includes a control mechanism 216 to move the piston 210 and bring the imaging substrate 214 into and out of contact with the wafer 218. In use the contact surface of the substrate 214 will face down towards the base 204 in use. In some embodiments, the headpiece 212 releasably holds the substrate 214 by applying a vacuum through a port. The stamp transfer apparatus 202 may include an adapter piece 222 as described with reference to FIG. 2B below to use a vacuum to secure the substrate 214. In some embodiments, the headpiece 212 releasably holds the substrate 214 via an adhesive.

To operate the apparatus 202, a user or operator may place the wafer 218 on the base 204 and place the substrate 214 on an underside of the headpiece 212 or the adapter piece 222. The user moves the control mechanism 216 down to engage the substrate 214 with the wafer 218. The liquid layer in the plurality of microwells 214 contacts the surface of the substrate 214 for a time sufficient to transfer a portion of each sample to the surface of the substrate 214. The user then proceeds to remove the substrate 214 from contact with the liquid layers by raising the headpiece 212 via the control mechanism 216. To soften the contact between the inverted mica disc substrate 214 and the silicon substrates 214 during the transfer process, a flexible PDMS backing 220 is placed between substrate 214 and the headpiece 212.

FIG. 2B is an isometric view of an example adapter piece 222 for the sampling apparatus. The adapter piece 222 may attach to the underside of the headpiece 201. The outlet port 302 connects to a vacuum pump (not shown) and the holes allow objects to be held in place by a vacuum. The adapter piece 306 may releasably hold substrate 214 in place by applying a vacuum through vacuum ports 308.

In another aspect, the disclosure provides a system comprising a stamp-transfer apparatus and a processor configured to perform a method of the disclosure.

While some embodiments of the disclosure have been described by way of illustration, it will be apparent that the disclosure can be put into practice with many modifications, variations and adaptations, and with the use of numerous equivalents or alternative solutions that are within the scope of persons skilled in the art, without departing from the spirit of the disclosure or exceeding the scope of the claims.

All publications, patents, and patent applications are herein incorporated by reference in their entirety to the same extent as if each individual publication, patent or patent application was specifically and individually indicated to be incorporated by reference in its entirety.

### EXAMPLES

The examples presented herein represent certain embodiments of the present disclosure. However, it is to be understood that these examples are for illustration purposes only and do not intend, nor should any be construed, to be wholly definitive as to conditions and scope of this disclosure. The examples were carried out using standard techniques, which are known and routine to those of skill in the art, except where otherwise described in detail.

### Example 1

### Fabrication of the Silicon Microwells

All fabrication was done in the clean room of the Chapel Hill Analytical and Nanofabrication Laboratory (CHANL). Photolithography for all wafers used a 5-inch, chrome on soda-lime photomask (Photo Sciences, Redland, CA, USA).

### Pure Silicon Wafers

The surface of a 3-inch P-type silicon wafer with a <100> orientation (University Wafers, Boston, MA, USA) was rinsed with a small amount of 10% HF to hydrogen terminate the wafer. Residual HF was removed by rigorously washing the wafer in deionized water and drying with nitrogen. The wafer was then spin coated with AZ 9260 positive photoresist (Merck, Darmstadt, Germany) at 3000 rpm for 45 s and baked on a hot plate at 115° C. for 1 min. Once the resist was baked, the wafer was submerged in deionized water for 1 min to rehydrate the resist. The wafer was dried with nitrogen and loaded into a Karl Suss MA6/BA6 mask aligner (Süss MicroTec, Garching, Germany) with a photomask and exposed to light for 35 s. Following exposure, the wafer was submerged into AZ 400K developer solution (Merck, Darmstadt, Germany) for 4 min. The wafer was washed with deionized water to remove residual developer solution and dried with nitrogen. Full removal of the exposed photoresist by the developer solution was confirmed with a Nikon Eclipse LV150 optical microscope (Nikon Metrology, Brighton, MI, USA) using 5× magnification.

The exposed silicon layer was etched by deep reactive ion etching (DRIE) using an Alcatel AMS 100 Deep Reactive Ion Etcher (Pfeiffer Vacuum, Asslar, Germany) for 30 s with the same Si etch program as above. After DRIE, the remaining photoresist was removed by submerging the wafer in acetone. The wafer was then washed with deionized water and dried with nitrogen.

### Oxide-Coated Silicon Wafers

A 3-inch P-type silicon wafer with a <100> orientation (University Wafers, Boston, MA, USA) was coated with about a ˜300 nm thick layer of oxide using plasma enhanced chemical vapor deposition (PECVD). The silicon dioxide layer was deposited using the Standard Oxide Etch process of an Advanced Vacuum Vision 310 Plasma Enhanced Chemical Vapor Deposition System (Plasma-Therm, Saint Petersburg, FL, USA) for 12 min. Approximate thickness of the oxide layer was confirmed with a Filmetrics F50 thin film mapper (KLA, Milpatas, CA, USA). Wafers were also purchased with a ˜300 nm thick layer of wet, thermally-grown oxide.

The oxide coated wafer was spin coated with MCC 80/20 Primer at 3000 rpm for 40 s followed by another spin coat with S1813 positive photoresist (Dupont Electronics & Industrial, Wilmington, DE, USA) at 3000 rpm for 40 s. Once spin coated, the wafer was baked on a hot plate at 105° C. for 1 min. The wafer was then placed in a Karl Suss MA6/BA6 mask aligner (Süss MicroTec, Garching, Germany) with a photomask and exposed to light for 15 s. Once exposed, the wafer was submerged in MF-319 developer solution (Dupont Electronics & Industrial, Wilmington, DE, USA) for about 1 min. The wafer was washed with deionized water to remove residual developer solution and dried with nitrogen. Full removal of the exposed photoresist by the developer solution was confirmed with a Nikon Eclipse LV150 optical microscope (Nikon Metrology, Brighton, MI, USA) using 5× magnification.

The exposed oxide was etched by submerging the wafer in a 7:1 solution of buffered HF (7:1 buffer of 40% NH4F:49% HF) for 1 min. Residual HF was washed off the wafer with deionized water, and the wafer was then dried with nitrogen. Complete removal of the exposed oxide layer was confirmed with the optical microscope. The etch time was adjusted as needed when using the wafers coated with thermal oxide because the thermal oxide slows the etch rate compared to oxide deposited with PECVD (Williams et al., 2003). The etch time was increased to 6 min to completely remove the thermal oxide.

To etch the exposed silicon, two different methods were used. The first method used the same Si etch process with the DRIE as described above. For the second method, the silicon was wet etched by submersion in a 30% KOH solution at 80° C. for 1.5 min. Residual KOH was removed by submerging the wafer in deionized water for 5 min, and the wafer was then dried with nitrogen.

### Cleaning Etched Wafers

Following fabrication, the wafers were cleaned to remove surface contaminants. The pure silicon wafer and oxide-coated silicon wafer were cleaned with a piranha etch by submersion in a 3:1 mixture of 18 M H2SO4: 30% H2O2 in a glass crystallization dish and left undisturbed for 10 min. After the piranha etch was complete, the wafers were carefully removed from the acid mixture and submerged in a deionized water bath for 5 min, and then transferred to a fresh deionized water bath and submerged for another 5 min. After rinsing, the wafers were dried with nitrogen and stored in petri dishes at ambient conditions. Prior to use for AFM experiments, wafers were cleaned with a BioForce UV Ozone Cleaner (BioForce Nanosciences, Virginia Beach, VA, USA) for 20 min.

### Microwell Characterization

After fabrication, the presence of the square microwells on the silicon substrates were large enough to see with the naked eye.

FIG. 1A shows an image 102 of microwell array 102 etched on Si wafer with ˜300 nm coating of SiO₂. Microwells 104 are, for example, 500 μm×500 μm squares spaced 2000 μm apart in a rectangular array.

To characterize the well depth, the wafers were imaged with a Hitachi S-4700 Cold Cathode Field Emission Scanning Electron Microscope (Hitachi, Schaumburg, IL, USA) to determine the well depth. The presence of different material layers on coated wafers may be confirmed.

FIG. 1B shows a representative SEM image 114 of microwell 102 cross section. The top ˜300 nm thick layer is SiO₂, and the bottom layer is Si. Total well depth for the microwells is ˜1 μm. Etch depths ranged from about 600 nm to about 1.3 μm, with most wafers having an etch depth close to 1 μm. Some variability is to be expected due to differences in the fabrication processes of different wafer types and inherent variability in fabrication. SEM also confirmed the presence of the two material layers (SiO2 and Si) on the oxide coated wafer.

### Example 2

### Stamp Transfer Apparatus

A custom transfer apparatus 202 was built to bring an imaging substrate 214 (mica in this example) into contact with the silicon microwells 104 and to transfer sample. The apparatus is described in greater detail in FIG. 2A. Any suitable automated stamp transfer apparatus could be utilized in accordance with the disclosure herein. To build the apparatus 202, the capping head of a FastRack 4008 Colt Strong bench top bottle capper (Amazon, Seattle, WA, USA) was fit with an ABS plastic adapter piece 222 having a port 302 for connection to a vacuum pump and small openings on the bottom, vacuum ports 308, to allow objects to be held on its base by vacuum. The wafer 218 was placed on a PLA plastic sample base 204 within the vertical range of the press apparatus 202.

To soften the contact between the inverted mica disc (substrate 214) and the silicon microwells 104 during the transfer process, a flexible PDMS backing 220 was made to fit against the adapter piece 222. The PDMS 220 was formed using the Sylgard® 184 silicone elastomeric kit (Dow Chemical, Midland, MI, USA) following the method outlined in Qin et al. (Qin et al., 2010; ref. 30).

### Example 3

### Depositing Sample Using the Silicon Microwells

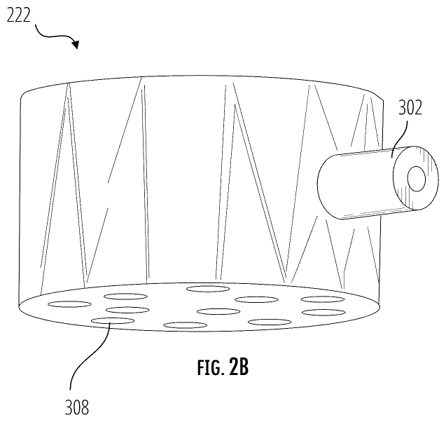

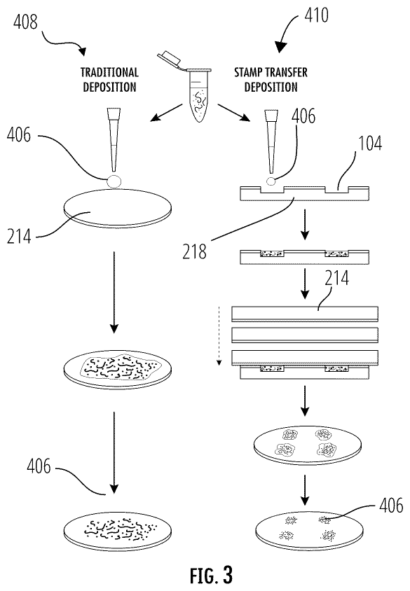

FIG. 3 illustrates example steps for traditional drop deposition method 408 versus stamp-transfer deposition 410. In the stamp transfer deposition 410 freshly cleaved mica discs (substrate 214) (15 mm diameter V1 muscovite mica, Ted Pella, CA) were mounted with double-sided tape to a flexible PDMS backing, which was made as previously described (30). Cleaned microwells 104 on a wafer 218 were secured on a sample stage with double-sided tape, filled with sample 406, and placed under the suspended mica so that the center microwell 104 aligned with the center of the mica disc (substrate 214). The mica was brought into contact with the silicon wafer piece 218 and held in contact for 1-2 seconds to transfer the sample before moving the mica out of contact. After the transfer, the mica disc (substrate 214) was removed from the PDMS backing and rinsed with water, wicked dry with filter paper, dried with nitrogen, and mounted to a glass slide with double-sided tape and imaged with AFM.

The traditional deposition method 408 by spotting the sample 406 directly onto a disc is shown on the left side of FIG. 3. The sample 406 is deposited directly onto the disc or wafer 214. The dried sample 406 is shown on the wafer.

### Example 4

### Protein and DNA Substrates

pUC-19 VSR (Robertson and Matson, 2012) plasmid was purified and cut with restriction enzymes. T-bulge DNA substrates for protein-DNA depositions was made from modifying a pUC-19 VSR plasmid, as previously described (Braford et al., 2020). Thermus aquaticus MutS was purified as previously described (25, 28, 29). Mica discs with a diameter of 15 mm (Ted Pella, CA) were used for depositions. H+-exchanged mica was prepared as previously described (18). Ethanolamine treated mica was prepared by placing freshly cleaved mica discs in a desiccator next to Parafilm containing 20 μL of ethanolamine for 15 min.

### DNA Sample Preparation

For DNA only depositions, linear pUC-19 VSR DNA was diluted to a concentration of 2 ng/μL in either low salt buffer (25 mM HEPES, 10 mM magnesium acetate (Mg(OAc)₂), 50 mM sodium acetate (NaOAc), pH=7.5) or high salt buffer (25 mM HEPES, 10 mM Mg(OAc)₂, 100 mM NaOAc, pH=7.5). Samples were deposited on untreated mica as described in Example 3.

The deposited samples were imaged with the Asylum MFP-3D AFM (Asylum Research, Santa Barbara, CA, USA) in tapping mode using Olympus tips (Olympus, Tokyo, Japan). All images were collected at a scan size of 2 μm×2 μm with 256×256 pixels at a scan rate of 1 Hz. Images were second order plane fitted and flattened using an in-house MATLAB program (Mathworks, Natick, MA, USA).

### Results and Discussion

To test whether the stamp-transfer deposition method with silicon microwells could deposit DNA in high salt buffer onto untreated mica, linearized pUC-19 VSR DNA (2708 base pairs) was used. This DNA shows very little adhesion to mica (<1 molecule/10×10 μm area) when deposited using the traditional drop method. Depositions are deemed successful with at least moderate DNA surface coverage (≥4 molecules/2×2 μm scan area) and no significant background contamination.

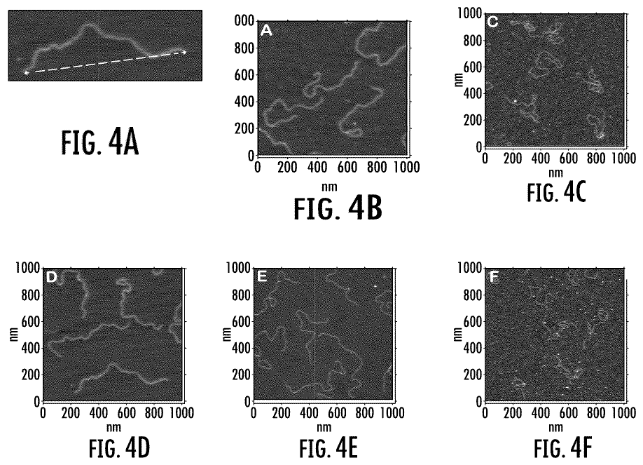

FIG. 4A, FIG. 4B, FIG. 4C, FIG. 4D, FIG. 4E, and FIG. 4F illustrate AFM images of linearized plasmid DNA deposited in different conditions. FIG. 4A illustrates an example of DNA end-to-end distance measurement.

FIG. 4B illustrates an AFM image of divalent cation assisted deposition in low salt buffer (25 mM HEPES, 10 mM Mg(OAc)₂, 50 mM NaOAc, pH=7.5) using untreated mica.

FIG. 4C illustrates an AFM image of divalent cation assisted deposition in high salt buffer (25 mM HEPES, 10 mM Mg(OAc)₂, 100 mM NaOAc, pH=7.5) using H+-exchanged mica.

FIG. 4D illustrates an AFM image of stamp transfer deposition in low salt buffer using untreated mica.

FIG. 4E illustrates an AFM image of stamp transfer deposition in high salt buffer using untreated mica.

FIG. 4F illustrates an AFM image of stamp transfer deposition in high salt buffer using H+-exchanged mica.

The AFM images show that using the microwell stamp-transfer method, linearized pUC-19 VSR DNA deposits well onto untreated mica in high salt as well as low salt (25 mM HEPES, 10 mM Mg(OAc)₂, 50 mM NaOAc, pH=7.5) buffers. The DNA surface coverage of the depositions using the silicon and oxide-coated silicon wafers is comparable to the coverage using the drop method of the same DNA concentration in low salt (>10 molecules/2 μm×2 μm). Furthermore, the background in the stamp-transfer method shows minimal contamination. Depositions using the oxide coated wafer generally show a slightly higher DNA surface coverage than depositions using the pure silicon wafer. These results indicate that the stamp transfer method can be used to efficiently transfer DNA to a freshly cleaved bare mica surface in both low and physiological salt concentrations.

### Example 5

### Polymer Chain Analysis of Deposited DNA Using Stamp Transfer Deposition

### Polymer Chain Statistics

The mean square end-to-end distance, [symbol] R² [symbol] , was calculated theoretically for linear pUC-19 VSR DNA using the persistence length, P, and contour length, L, of the DNA. For a polymer molecule in 2D, the theoretical mean square end-to-end distance, [symbol] R² [symbol] _{2D}, is given by the equation (Rivetti et al., 1996)

$${〈 {R}^{2} 〉}_{2 D} = 4 P L [ 1 - \frac{2 P}{L} ( 1 - {e}^{- \frac{L}{2 P}} ) ] \qquad ( 1 )$$

For a polymer molecule in 3D, the theoretical mean square end-to-end distance, [symbol] R² [symbol] _{3D}, is given by the equation (Flory, 1969):

$${〈 {R}^{2} 〉}_{3 D} = 2 P L [ 1 - \frac{P}{L} ( 1 - {e}^{- \frac{L}{P}} ) ] \qquad ( 2 )$$

When the 3D chain is projected onto the x-y plane, the [symbol] R² [symbol] becomes (Rivetti et al., 1996):

$${〈 {R}^{2} 〉}_{proj .} = 〈 {R}_{x}^{2} 〉 + 〈 {R}_{y}^{2} 〉 = \frac{2}{3} {〈 {R}^{2} 〉}_{3 D} \qquad ( 3 )$$

The mean square end-to-end distance of DNA was determined experimentally by imaging the molecules deposited on the surface with AFM and measuring the distance between the two DNA ends for each molecule.

### Results and Discussion

The deposition process for AFM requires molecules in a 3D solution to approach and bind to a 2D surface. For long chain polymers such as DNA, the transition from 3D to 2D modifies the conformation of the molecule. As the molecule interacts with the surface during deposition, two potential cases can occur. The DNA molecules may freely rearrange into a 2D conformation in solution near the surface before being captured in a particular conformation. Alternatively, DNA molecules may bind to the surface before undergoing any rearrangement, resulting in a conformation that resembles a projection of the molecules' 3D conformation on the 2D surface. This process is referred to as kinetic trapping (18). For the first case (conformational equilibration on the surface), DNA molecules deposited on the surface are indistinguishable in appearance and dimension from an ensemble of molecules at equilibrium in 2D. This allows meaningful information about the molecules' structure to be extracted from the 2D images. In the second case, the molecules' conformations are a reflection of the history of their approach to the surface; therefore, intrinsic conformations of the molecules cannot be easily distinguished from conformations induced by surface effects (19). DNA molecules deposited using the traditional drop method at low salt have been previously shown to undergo 2D rearrangement (18). These two regimes can be delineated by determining the mean square end-to-end distance, [symbol] R² [symbol] , of the DNA molecules and using the worm-like chain model (18). DNA that has equilibrated on the surface will have a more extended conformation, while DNA that is kinetically trapped will be more compact. The more extended the DNA molecule is, the greater the distance between its two ends, or end-to-end distance.

The theoretical [symbol] R² [symbol] _{2D}, [symbol] R² [symbol] _{3D}, and [symbol] R² [symbol] ₚᵣₒⱼ. for DNA the length of pUC-19 VSR (920.7 nm) were calculated for comparison. The theoretical [symbol] R² [symbol] , values and the experimentally determined [symbol] R² [symbol] , values for different depositions are shown in Table 1.

TABLE 1
Mean-square end-to-end distance of 2708 bp DNA strands
deposited onto mica

| Theoretical [symbol] R² [symbol] _{2D} (nm²) | | | 164,100 | |
|---|---|---|---|---|
| Theoretical [symbol] R² [symbol] _{3D} (nm²) | | | 87,100 | |
| Theoretical [symbol] R² [symbol] _{proj.} (nm²) | | | 58,100 | |
| Deposition | Buffer | Surface | | Standard |
| Method | Condition | Treatment | [symbol] R² [symbol] (nm²) | Error (nm²) |
| Drop Method | Low Salt | None | 221,000 | 33,200 |
| Stamp Transfer | Low Salt | None | 211,300 | 11,800 |
| Stamp Transfer | High Salt | None | 165,500 | 9,900 |
| Drop Method | High Salt | H⁺-exchanged | 52,500 | 1,100 |
| Stamp Transfer | High Salt | H⁺-exchanged | 48,800 | 500 |

The pUC-19 VSR DNA deposited in low salt was characterized with drop deposition and stamp-transfer deposition because it has been previously shown that DNA equilibrates to a 2D conformation under these conditions using the drop method (18). The experimental [symbol] R² [symbol] values determined from the two deposition methods are within error of one another and consistent with the DNA equilibrating in 2D before adhering to the surface (Table 1). The slightly higher experimental [symbol] R² [symbol] values relative to the theoretical [symbol] R² [symbol] _{2D} value results from effects of excluded volume interactions for longer DNA strands that are not fully included in the theory (18). The [symbol] R² [symbol] value for the stamp-transfer depositions in high salt is also consistent with 2D equilibration of the DNA conformation on the surface; however, its value is lower than that of the low-salt deposition and closer to the theoretical [symbol] R² [symbol] _{2D} (Table 1). This lower [symbol] R² [symbol] is not surprising because the flexibility of DNA increases as the ionic strength of solution increases (20, 21).

The [symbol] R² [symbol] values determined for DNA deposited with the stamp-transfer method indicate that DNA absorbed on the mica surface equilibrates in 2D prior to adhering to the surface, as it does with the drop method. These results can be seen visually in the AFM images of the DNA, which show that the DNA molecules on the surface are not condensed and have few strand crossings, as illustrated in FIG. 4D and FIG. 4E.

To examine if any 2D equilibration occurs in the wells prior to the stamp-transfer process, the depositions were repeated using positively-charged H⁺-exchanged mica. DNA deposited on H⁺-exchanged mica at low salt using the drop method does not undergo 2D rearrangement and binds the mica in a “kinetically-trapped” state, with the experimental [symbol] R² [symbol] being similar to the theoretical [symbol] R² [symbol] _{3D} (19) (Table 1). If DNA deposited using the stamp-transfer method undergoes 2D rearrangement within the microwells before transferring to the surface, we would expect the DNA deposited on H⁺-exchanged mica to still be in 2D equilibrium; however, the [symbol] R² [symbol] value of stamp transferred DNA on H⁺-exchanged mica indicates the DNA is kinetically trapped. Taken together, these results indicate that the 2D rearrangement of DNA in the stamp-transfer method occurs on the surface and/or during the stamp-transfer process itself.

### Example 6

### Stamp Transfer Deposition Improves Resolution of Protein-Induced DNA Bend Angles

### A. MutS Bound to DNA

### Expression and Purification MutS (T. Aquaticus MutS)

MutS (T. aquaticus MutS) was purified as previously described (Biswas and Hsieh, 1996, Ref. 28; Sharma et al., 2013, Ref. 29; Leblanc et al., 2018, Ref. 25). This protein is a mutant (C42A/M88C) designed for labeling for single molecule fluorescence resonance energy transfer (FRET) experiments. The ATPase activity and mismatch affinity of the mutant has been previously verified to be similar to the wild type protein (Qiu et al., 2015, Ref. 24).

### DNA Substrate Preparation

The pUC-19 VSR plasmid was modified to make the circular T-Bulge substrate. The plasmid was cut with Xmn1 and Nde1 (NEB, Ipswitch, MA, USA) to generate a 572 base pair strand of homoduplex DNA and a 2136 base pair strand of heteroduplex DNA. The T-bulge site is 227 base pairs from the end of the heteroduplex DNA strand.

### Sample Preparation for AFM

For protein-DNA depositions, complexes were formed by mixing T. aquaticus MutS and T-bulge DNA in low or high salt buffer and incubating at room temperature for 2 min in the absence of ATP or 5 min in the presence of ATP. Final concentrations were 2 ng/μL T-bulge DNA with 50 nM and 60 nM protein in the absence and presence of ATP, respectively. The concentration of protein was raised in the presence of ATP because low binding of MutS to the DNA was observed when 50 nM of protein was used. MutS has been found to have a reduced affinity for mismatch sites in the presence of ATP, which may explain the lower amount of protein bound (Junop et al., 2001).

### B. E. Coli RNA Polymerase-Promoter Interactions

### Expression and Purification of RNA Polymerase

His6-tagged E. coli RNA polymerase holoenzyme was purified using established methods (Uptain and Chamberlin, 1997).

### DNA Substrate Preparation

Plasmid pUC-19-VSR was grown and isolated from Stbl2 E. coli using a HiSpeed Plasmid Midi Kit (Qiagen, Hilden, Germany). The plasmid was linearized using Xnm1 (NEB, Ipswitch, MA, USA). Linearized DNA was cleaned with the QIAquick PCR Purification Kit (Qiagen, Hilden, Germany). Linear pUC-19 VSR cut with Xmn1 contains two promoter regions: the 104 base pair AmpR promoter located 189 base pairs from the DNA end, and the 30 base pair lac promoter located 923 base pairs from the same DNA end.

### Sample Preparation for AFM

Linear DNA was mixed with RNA polymerase in high salt AFM buffer (25 mM HEPES, 100 mM NaOAC, 10 mM Mg(OAc)₂, pH=7.5) containing 1 mM DTT for a final concentration of 2 ng/μL DNA and 12 nM protein. The sample was incubated at 37° C. for 15 min to form open promoter complexes. Sample was immediately deposited after incubation.

For low salt experiments, RNA polymerase was mixed with linear DNA in low salt AFM buffer (25 mM HEPES, 50 mM NaOAC, 10 mM Mg(OAc)₂, pH=7.5) containing 1 mM DTT for a final concentration of 20 nM protein and 4 ng/μL DNA. The mixture was heated at 37° C. for 15 min to form open promoter complexes. After heating, the reaction mixture was diluted with more buffer for a final concentration of 10 nM protein and 2 ng/μL DNA.

### C. Sample Depositions and Imaging

### Deposition of Sample

Samples were dispensed into the wells of wafer pieces (oxide coated, etch depth ˜1 μm) and transferred to freshly cleaved ruby mica as described in Example 3. To prepare positively-charged mica using ethanolamine depositions, freshly cleaved discs of ruby mica were placed in a desiccator next to a piece of Parafilm containing 20 μL of ethanolamine for 15 min to functionalize the mica surface.

For drop method depositions, 10 μL of the reaction sample was applied to the functionalized mica. The mica was then washed with water, blotted with filter paper, and fully dried with nitrogen.

### Imaging and Image Analysis

Images were collected as described in Example 4. The volumes of the proteins, the positions of the proteins on the DNA, and the DNA bend angles were measured with an in-house MATLAB program (Mathworks, Natick, MA, USA). The protein position was measured as the distance from the center of the protein complex to the nearest DNA end. Bound proteins were defined as specific if they were within one standard deviation of position of the T-bulge site. In cases where two proteins were bound to the DNA, the complex closest to the expected position of the T-bulge site was considered specific. DNA bend angles were measured as the deviation of the DNA strand from 180°. Plots of the position, volume, and bend angle distributions were generated in OriginPro (Origin Labs, Northampton, MA, USA). For the RNA polymerase-promotor complexes, proteins are defined as specific if they were within one standard deviation of the AmpR promoter region.

### D. Results & Discussion

To confirm the viability of the stamp-transfer deposition method for protein-DNA complexes, two different protein-DNA complexes were tested: (A) the DNA mismatch recognition protein MutS bound to DNA containing a mismatch and (B) RNA polymerase bound to promoter containing DNA. The results confirmed that the DNA-protein complexes could be efficiently transferred using the stamp-transfer deposition method at both low and high salt. The results were also compared to the same experiments done using the drop method, as well as to previously published data that used the drop deposition method.

Complexes of MutS bound to linear DNA with a single thymidine insert (T-bulge) located 227 base pairs (76 nm) away from the nearest end were examined. Previous AFM studies show that MutS binds with high affinity and specificity for the T-bulge site on DNA (15, 16). Consistent with these studies (15, 22, 23), MutS showed high specificity for the T-bulge in AFM images using the stamp-transfer (low and high salt, LS and HS) and drop (low salt, LS) deposition methods.

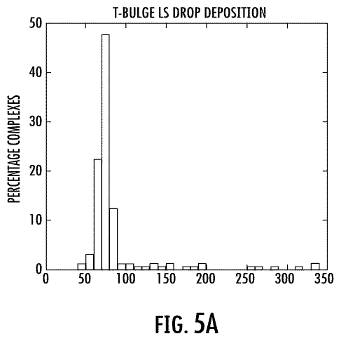

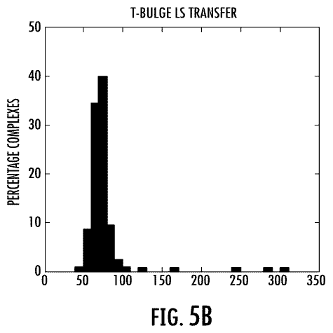

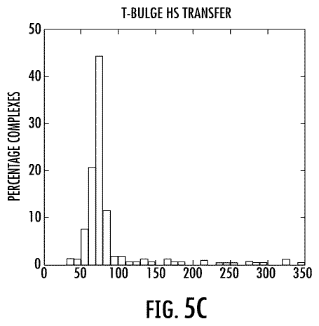

FIG. 5A, FIG. 5B, and FIG. 5C are graphs of MutS showing high specificity for a T-bulge under different deposition conditions.

In FIG. 5A and FIG. 5B, position distributions of T. aquaticus MutS bound to linear DNA containing a T-bulge site for low salt depositions are illustrated. In FIG. 5A, position distributions are illustrated using the traditional drop method. In FIG. 5B, position distributions are illustrated using the stamp-transfer method.

In FIG. 5C, position distributions are illustrated using the stamp-transfer method at high salt. The plotted position is the distance of MutS from the nearest end (short arm length) of the DNA length. The T-bulge is located 227 base pairs (˜76 nm) from the end. A schematic of the T-bulge position on the DNA is shown below. Protein bound to the DNA ends was not included in the position analysis.

The conformational properties of the specifically bound complexes (defined as complexes positioned within one standard deviation of the T-bulge) were also analyzed. Previous AFM studies showed that MutS adopts two conformations when bound to a T-bulge: one in which the DNA is unbent (˜0°) and one in which the DNA is bent by ˜45°, but only a single bent (˜45°) conformation when bound to nonspecific sites.

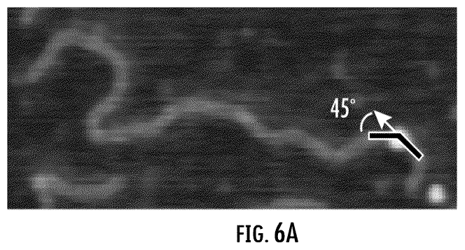

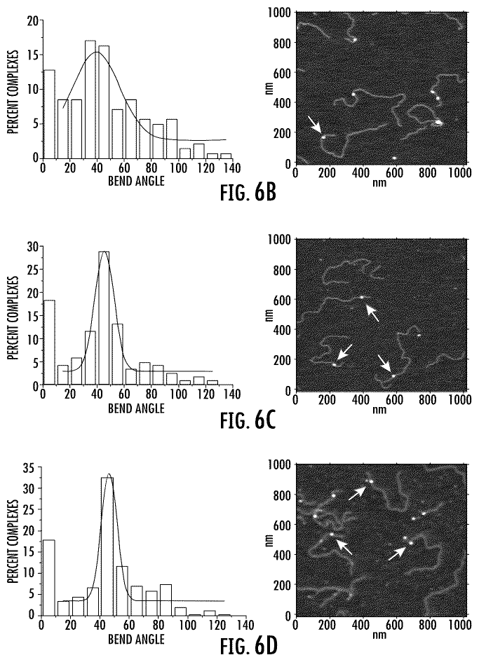

FIG. 6A, FIG. 6B, FIG. 6C, and FIG. 6D show histograms of DNA bend angles induced by T. aquaticus MutS bound to the T-bulge site and representative AFM images. FIG. 6A illustrates an example of bend angle measurement. As illustrated, a section of a complex that includes a bend is identified. The straight portions of the complex are overlaid with two lines. An angle between the two measured at a point of intersection is measured. In FIG. 6A, the measurement is 45 degrees.

FIG. 6B illustrates a graph of DNA bend angles of specific complexes and a corresponding AFM image for complexes deposited with divalent cation assisted method in low salt buffer. FIG. 6C illustrates a graph of DNA bend angles of specific complexes and a corresponding AFM image for complexes deposited with stamp transfer method in low salt buffer. FIG. 6D illustrates a graph of DNA bend angles of specific complexes and a corresponding AFM image for complexes deposited with stamp transfer method in high salt buffer.

In the associated graphs for each image, the second peak of each distribution was fitted with a Gaussian curve. The mean bend for the peak was 40±17° for FIG. 6B, 45±7° for FIG. 6C, and 46±6° for FIG. 6D. The arrows in the AFM images indicate specifically bound protein.

Consistent with previous the experiments MutS-T-bulge complexes in all the experiments exhibit two populations of conformations with bend angle peaks centered at 0° and ˜45°, while only a bent conformation is seen for nonspecific sites. Complexes deposited by the stamp transfer method show narrower distributions of bend angles in both low and high salt compared to complexes deposited by the drop method in low salt. Specifically, Gaussian fits of the bent state yield standard deviations of ˜6° for the low and high salt stamp-transfer depositions and 17° for the drop method. Wang et al. also reported a much higher standard deviation of 38° for the bent state using the drop method.

Experiments examining RNA polymerase-induced bending on promoter DNA also revealed significantly tighter bend angle distributions for the stamp-transfer method (49°±8°) compared to the drop method (46°±17°).

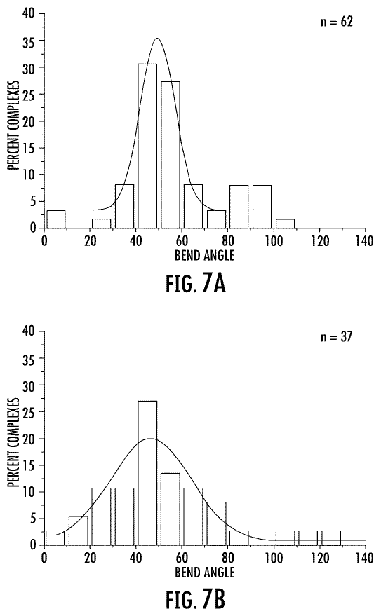

FIG. 7A and FIG. 7B illustrate RNA polymerase induced DNA bending at the AmpR site for different deposition methods. FIG. 7A illustrates a histogram of DNA bend angles induced by RNA polymerase (RNAP) bound to the AmpR promoter for the transfer deposition. The peak is fit to a Gaussian to give a mean bend angle of 49±8°.

FIG. 7B illustrates a histogram of DNA bend angles induced by RNAP bound to the AmpR promoter for the drop deposition. The peak is fitted with a Gaussian curve to give a mean bend angle of 46±17°.

Taken together, these results indicate that deposition of protein-DNA complexes using the stamp-transfer method results in improved resolution of the protein-DNA conformational states compared deposition using the drop method, and they suggest that standard drop deposition methods result in greater distortion of the conformations of the protein-DNA complexes than the stamp-transfer method.

In the drop method where DNA reorients on the surface before adhering, part of the DNA may stick first, constraining the conformations of the rest of the DNA and resulting in distortion from its ground state configuration. This situation could be worse for protein-DNA complexes for two reasons. Their conformations are more “rigid”, and proteins generally adhere to the surface significantly better than DNA, which may cause the complex to be distorted if the DNA has not yet rearranged into a 2D conformation. An increase in the resolution of bend angles could occur if the complexes were “pre-spread” such that they adopted a 2D-like conformation before depositing on mica. Further, the results examining the [symbol] R² [symbol] of DNA deposition on H⁺-exchanged mica indicate that the DNA fragments are not adopting a 2D conformation in the microwells. Consequently, these results suggest that the protein-DNA complexes are reorienting during the stamp-transfer process prior to adhering to the surface.

### Example 7

### Multi-Transfer Depositions

For the experiments discussed above, the oxide-coated silicon wafers contained 6-9 microwells and were all filled with the same sample. Clearly, individual microwells can be filled with different samples to allow high-throughput sample depositions. For “high-throughput” studies, a single microwell wafer was used to transfer different samples to same mica surface: circular T-bulge DNA alone, circular T-bulge DNA+MutS, and circular T-bulge DNA+MutS+ATP. The circular DNA alone was placed in the column between the two MutS samples to determine if the samples containing MutS bleed into the nearby samples.

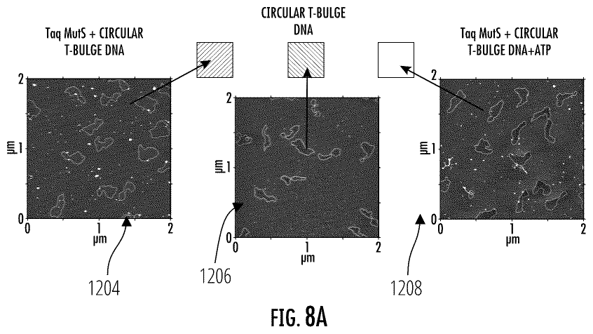

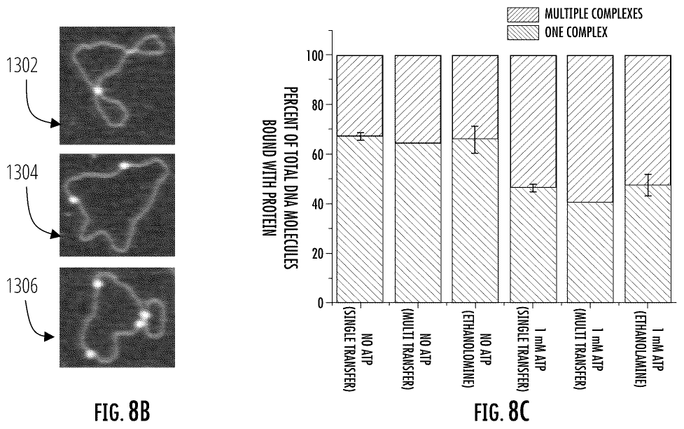

FIG. 8A, FIG. 8B, and FIG. 8C illustrate multi-transfer deposition of circular T-bulge DNA and T. aquaticus MutS in the presence and absence of ATP.

FIG. 8A illustrates an AFM image 1204 of a sampling setup for multi-transfer deposition showing microwells filled with circular T-bulge DNA and T. aquaticus MutS in the absence of ATP. AFM image 1206 illustrates a sampling setup for multi-transfer deposition showing microwells filled with circular T-bulge DNA alone. AFM image 1208 illustrates a sampling setup for multi-transfer deposition showing microwells filled with circular T-bulge DNA plus T. aquaticus MutS in the presence of ATP. The representative AFM images are taken from different areas of the mica surface. The presence of circular T-bulge DNA without any protein in the center region confirms that bleed over did not occur between samples, even though the mica was rinsed with water after stamp-transfer and prior to imaging.

To compare the results of the individual stamp-transfer and drop methods, the ATPase properties of MutS were exploited. After binding the mismatch, ATP induces conformational changes in MutS that lead to the formation of a mobile clamp state that can move away from the mismatch (24-26), allowing another MutS to bind the mismatch (24, 26, 27). As such, one expects an increase in the number of MutS proteins bound to circular T-bulge DNA in the presence of ATP relative to in its absence. For each condition, the number of MutS proteins bound to the circular T-bulge DNA was determined and compared to the same experiments done using individual stamp-transfer depositions and individual drop depositions on ethanolamine-treated mica.

FIG. 8B shows zoomed AFM images of circular T-bulge DNA with one, two, or four complex(es). Image 1302 illustrates the circular T-bulge DNA with one complex. Image 1304 illustrates the circular T-bulge DNA with two complexes. Image 1306 illustrates the circular T-bulge DNA with four complexes.

FIG. 8C illustrates stacked bar graphs of the percentages of DNA molecules bound with a single MutS complex versus two or more complexes. Percentages are shown for individual transfer depositions, multi-transfer deposition, and traditional depositions using ethanolamine treated mica. The sum of the percentages for each experiment is normalized to 100%. A chi-square test of independence of the single transfer deposition dataset verifies that the difference between the ATP and no ATP conditions is statistically significant (p value=0.00071).

The addition of ATP to MutS+DNA results in an increase in the percentage of DNAs that have more than one MutS bound. No protein-DNA complexes are observed in any of the depositions with circular T-bulge alone. In the absence of ATP, the percentage of bound DNA molecules with more than one MutS protein is very similar between the “high-throughput” deposition, the individual stamp-transfer and drop depositions (36%, 34%, and 35%, respectively). In the presence of ATP, this percentage increases and is also similar with the high-throughput depositions and the individual stamp-transfer depositions and the drop depositions (59%, 54%, and 54%, respectively).

Taken together, these results indicate that multiple different samples can be deposited simultaneously using our stamp-transfer method. The ability to deposit multiple samples at once on a single piece of mica not only allows high-throughput depositions, but also removes systematic errors that can arise from multiple depositions on different mica surfaces.

While the presently disclosed subject matter has been disclosed with reference to specific embodiments, it is apparent that other embodiments and variations of this presently disclosed subject matter can be devised by others skilled in the art without departing from the true spirit and scope of the presently disclosed subject matter.

### REFERENCES

All references listed in the instant disclosure, including but not limited to all patents, patent applications and publications thereof, scientific journal articles, and database entries are incorporated herein by reference in their entireties to the extent that they supplement, explain, provide a background for, and/or teach methodology, techniques, and/or compositions employed herein. The discussion of the references is intended merely to summarize the assertions made by their authors. No admission is made that any reference (or a portion of any reference) is relevant prior art. Applicants reserve the right to challenge the accuracy and pertinence of any cited reference.
1. K. C. Bradford et al., Dynamic human MutSα-MutLα complexes compact mismatched DNA. Proceedings of the National Academy of Sciences 117, 16302-16312 (2020).
2. M. Tisma et al., Dynamic ParB-DNA interactions initiate and maintain a partition condensate for bacterial chromosome segregation. Nucleic Acids Res 51, 11856-11875 (2023).
3. P. Kaur et al., High-speed AFM imaging reveals DNA capture and loop extrusion dynamics by cohesin-NIPBL. J Biol Chem 299, 105296 (2023).
4. J. L. Wojtaszek et al., Structure-specific roles for PolG2-DNA complexes in maintenance and replication of mitochondrial DNA. Nucleic Acids Res 51, 9716-9732 (2023).
5. H. Burdett et al., BRCA1-BARD1 combines multiple chromatin recognition modules to bridge nascent nucleosomes. Nucleic Acids Res 51, 11080-11103 (2023).
6. Y. Y. Lin et al., Epigenetic Histone Modifications H3K36me3 and H4K5/8/12/16ac Induce Open Polynucleosome Conformations via Different Mechanisms. J Mol Biol 436, 168671 (2024).
7. S. Mohapatra, C.-T. Lin, X. A. Feng, A. Basu, T. Ha, Single-Molecule Analysis and Engineering of DNA Motors. Chemical Reviews 120, 36-78 (2020).
8. E. M. Irvin, H. Wang, Single-molecule imaging of genome maintenance proteins encountering specific DNA sequences and structures. DNA Repair 128, 103528 (2023).
9. M. K. M. Cajili, E. I. Prieto, “Atomic Force Microscopy Characterization of Reconstituted Protein-DNA Complexes” in Bacterial Chromatin: Methods and Protocols, R. T. Dame, Ed. (Springer US, New York, NY, 2024), 10.1007/978-1-0716-3930-6_14, pp. 279-295.
10. S. Filliaux, Z. Sun, Y. L. Lyubchenko, Nanoscale Structure, Interactions, and Dynamics of Centromere Nucleosomes. Biomacromolecules 25, 4715-4727 (2024).
11. S. N. Andres, Z. M. Li, D. A. Erie, R. S. Williams, Ctp1 protein-DNA filaments promote DNA bridging and DNA double-strand break repair. Journal of Biological Chemistry 294, 3312-3320 (2019).
12. E. C. Beckwitt, M. Kong, B. Van Houten, Studying protein-DNA interactions using atomic force microscopy. Seminars in Cell & Developmental Biology 73, 220-230 (2018).
13. D. M. Bangalore, I. Tessmer, Direct hOGG1-Myc interactions inhibit hOGG1 catalytic activity and recruit Myc to its promoters under oxidative stress. Nucleic Acids Res 50, 10385-10398 (2022).
14. D. A. Erie, K. R. Weninger, Single molecule studies of DNA mismatch repair. DNA Repair (Amst) 20, 71-81 (2014).
15. D. Wu et al., Visualizing the Path of DNA through Proteins Using DREEM Imaging. Mol Cell 61, 315-323 (2016).
16. H. Sanchez, M. Reuter, M. Yokokawa, K. Takeyasu, C. Wyman, Taking it one step at a time in homologous recombination repair. DNA Repair (Amst) 20, 110-118 (2014).
17. Y. L. Lyubchenko, L. S. Shlyakhtenko (2016) Imaging of DNA and Protein-DNA Complexes with Atomic Force Microscopy. in Crit Rev Eukaryot Gene Expr, pp 63-96.
18. P. Wagner (1998) Immobilization strategies for biological scanning probe microscopy. in FEBS letters, pp 112-115.
19. N. Santos, and Miguel Castanho, An overview of the biophysical applications of atomic force microscopy. Biophysical Chemistry 107, 133-149 (2003).
20. A. Podesta et al. (2004) Atomic force microscopy study of DNA deposited on poly L-ornithine-coated mica. in J Microsc, pp 236-240.
21. D. Ristic, H. Sanchez, C. Wyman, Sample preparation for SFM imaging of DNA, proteins, and DNA-protein complexes. Methods Mol Biol 783, 213-231 (2011).
22. L. S. Shlyakhtenko et al., Silatrane-based surface chemistry for immobilization of DNA, protein-DNA complexes and other biological materials. Ultramicroscopy 97, 279-287 (2003).
23. M. Bezanilla, C. J. Bustamante, H. G. Hansma, Improved visualization of DNA in aqueous buffer with the atomic force microscope. Scanning Microscopy 7, 1145-1148 (1994).
24. C. Bustamante, D. A. Erie, D. Keller, BIOCHEMICAL AND STRUCTURAL APPLICATIONS OF SCANNING FORCE MICROSCOPY. Current Opinion in Structural Biology 4, 750-760 (1994).
25. H. G. Hansma, I. Revenko, K. Kim, D. E. Laney, Atomic force microscopy of long and short double-stranded, single-stranded and triple-stranded nucleic acids. Nucleic Acids Res 24, 713-720 (1996).
26. H. G. Hansma, D. E. Laney, DNA binding to mica correlates with cationic radius: assay by atomic force microscopy. Biophys J 70, 1933-1939 (1996).
27. O. Piétrement et al. (2003) Reversible Binding of DNA on NiCl 2-Treated Mica by Varying the Ionic Strength. in Langmuir, pp 2536-2539.
28. M. Bezanilla, S. Manne, D. E. Laney, Y. L. Lyubchenko (1995) Adsorption of DNA to mica, silylated mica, and minerals: characterization by atomic force microscopy. in Langmuir.
29. T. Jain, P. Sheehan, J. Crum, B. Carragher, C. S. Potter (2012) Spotiton: a prototype for an integrated inkjet dispense and vitrification system for cryo-TEM. in J Struct Biol, pp 68-75.
30. I. Razinkov et al. (2016) A new method for vitrifying samples for cryoEM. in J Struct Biol (Elsevier Inc.), pp 190-198.
31. D. M. Bangalore et al., Automated AFM analysis of DNA bending reveals initial lesion sensing strategies of DNA glycosylases. Scientific Reports 10, 15484 (2020).
32. Z. Li (2019) Developing New Afm Imaging Technique and Software for DNA Mismatch Repair. (The University of North Carolina at Chapel Hill, United States—North Carolina), p 272.
33. M. Qin et al. (2007) Bioactive Surface Modification of Mica and Poly(dimethylsiloxane) with Hydrophobins for Protein Immobilization. in Langmuir, pp 4465-4471.
34. Y. Fang, J. H. Hoh, Surface-directed DNA condensation in the absence of soluble multivalent cations. Nucleic Acids Res 26, 588-593 (1998).
35. E. E. Lentz (2022) New Methods of Deposition for Atomic Force Microscopy Studies of Biomolecules. (The University of North Carolina at Chapel Hill, United States—North Carolina), p 154.
36. C. Rivetti, M. Guthold, C. Bustamante, Scanning force microscopy of DNA deposited onto mica: equilibration versus kinetic trapping studied by statistical polymer chain analysis. Journal of Molecular Biology 264, 919-932 (1996).
37. C. Bustamante, and C. Rivetti, Visualizing Protein-Nucleic Acid Interactions on a Large Scale with the Scanning Force Microscope. Annual Review of Biophysics and Biomolecular Structure 25, 395-429 (1996).
38. G. S. Manning, The Persistence Length of DNA Is Reached from the Persistence Length of Its Null Isomer through an Internal Electrostatic Stretching Force. Biophysical Journal 91, 3607-3616 (2006).
39. S. Guilbaud, L. Salomé, N. Destainville, M. Manghi, and C. Tardin, Dependence of DNA Persistence Length on Ionic Strength and Ion Type. Physical Review Letters 122, 028102 (2019).
40. Y. Yang, L. Sass, C. Du, P. Hsieh, D. A. Erie, Determination of protein-DNA binding constants and specificities from statistical analyses of single molecules: MutS-DNA interactions. Nucleic Acids Res in press (2005).
41. I. Tessmer et al., Mechanism of MutS searching for DNA mismatches and signaling repair. J Biol Chem 283, 36646-36654 (2008).
42. T. A. Kunkel, D. A. Erie, DNA mismatch reapir. Annu Rev Biochem 74, 681-710 (2005).
43. H. Wang et al., DNA bending and unbending by MutS govern mismatch recognition and specificity. Proc Natl Acad Sci USA 100, 14822-14827 (2003).
44. C. Rivetti, M. Guthold, C. Bustamante, Wrapping of DNA around the E. coli RNA polymerase open promoter complex. Embo J 18, 4464-4475 (1999).
45. A. G. Kozlov, T. M. Lohman, Stopped-flow studies of the kinetics of single-stranded DNA binding and wrapping around the Escherichia coli SSB tetramer. Biochemistry 41, 6032-6044 (2002).
46. W. A. Rees, R. W. Keller, J. P. Vesenka, G. Yang, C. Bustamante, Evidence of DNA bending in transcription complexes imaged by scanning force microscopy. Science 260, 1646-1649 (1993).
47. R. Qiu et al., MutL traps MutS at a DNA mismatch. Proc Natl Acad Sci USA 112, 10914-10919 (2015).
48. S. J. LeBlanc et al., Coordinated protein and DNA conformational changes govern mismatch repair initiation by MutS. Nucleic Acids Res 46, 10782-10795 (2018).
49. P. Hao et al., Recurrent mismatch binding by MutS mobile clamps on DNA localizes repair complexes nearby. Proceedings of the National Academy of Sciences 117, 17775-17784 (2020).
50. S. Gradia et al., hMSH2-hMSH6 forms a hydrolysis-independent sliding clamp on mismatched DNA. Mol Cell 3, 255-261 (1999).
51. C. Jeong et al., MutS switches between two fundamentally distinct clamps during mismatch repair. Nature Structural & Molecular Biology 18, 379-385 (2011).
52. I. Biswas, and P. Hsieh, Identification and Characterization of a Thermostable MutS Homolog from Thermus aquaticus. Journal of Biological Chemistry 271, 5040-5048 (1996).
53. A. Sharma, C. Doucette, F. N. Biro, and M. M. Hingorani, Slow conformational changes in MutS and DNA direct ordered transitions between mismatch search, recognition and signaling of DNA repair. Journal of Molecular Biology 425, 4192-4205 (2013).
54. D. Qin, Y. Xia, G. M. Whitesides, Soft lithography for micro- and nanoscale patterning. Nat Protoc 5, 491-502 (2010).
55. W. Chen et al., Difference in anisotropic etching characteristics of alkaline and copper based acid solutions for single-crystalline Si. Scientific Reports 8, 3408 (2018).
56. Vh Junop, M. S., G. Obmolova, K. Rausch, P. Hsieh, and W. Yang (2001). “Composite Active Site of an ABC ATPase: MutS Uses ATP to Verify Mismatch Recognition and Authorize DNA Repair.” Molecular Cell 7(1): 1-12.
57. Uptain, S. M., and M. J. Chamberlin (1997). “Escherichia coli RNA polymerase terminates transcription efficiently at rho-independent terminators on single-stranded DNA templates.” Proceedings of the National Academy of Sciences of the USA 94(25): 13548-13553.
58. AB Robertson, SW Matson (2012) Reconstitution of the very short patch repair pathway from Escherichia coli Journal of Biological Chemistry 287 (39), 32953-32966.

1. A stamp-transfer deposition method to immobilize a biomolecule and/or polymer on a surface of a substrate, the method comprising:
dispensing a liquid sample comprising one or more biomolecule and/or polymer into at least one microwell present on a wafer to form a thin liquid layer;
contacting the liquid layer in the at least one microwell with the surface of the substrate for a time sufficient to transfer a portion of the sample to the surface such that the biomolecule and/or polymer adheres to the surface of the substrate; and
removing the surface from contact with the liquid layer with the biomolecule and/or polymer being immobilized on the surface of the substrate; and
optionally, drying, or rinsing and drying, the substrate in preparation for scanning probe microscopy (SPM).

2. The method of claim 1, wherein the wafer comprises a plurality of microwells.

3. The method of claim 2, wherein the plurality of microwells is arranged in an array on wafer sufficiently separate from each other to avoid sample bleed over upon removal of the surface from contact with the liquid layer.

4. The method of claim 2, wherein the sample dispensed into each of the plurality of microwells is independently identical or different.

5. The method of claim 1, wherein dispensing is performed by an inkjet-type device or by a microfluidic device.

6. The method of claim 1, wherein the wafer comprises a semiconductor wafer or other silicon-based wafer, with or without a coating.

7. The method of claim 2, wherein the microwells are etched into the wafer.

8. The method of claim 1, wherein the substrate is suitable for scanning probe microscopy (SPM).

9. The method of claim 1, wherein the substrate is selected from the group consisting of mica, gold, glass, quartz, graphite, silicon, and plastic, and wherein a surface thereof is treated or untreated.

10. The method of claim 1, wherein the biomolecule and/or polymer is selected from the group consisting of nucleic acids, proteins, protein-nucleic acid complexes, carbohydrates, polysaccharides, cellulose, synthetic polymers, cells, subcellular organelles, bacteria, and viruses.

11. The method of claim 1, wherein scanning probe microscopy is selected from the group consisting of atomic force microscopy (AFM), scanning tunneling microscopy (STM), near-field scanning optical microscopy (SNOM/NSOM), scanning electron microscopy and electrochemical AFM.

12. A high-throughput method for depositing biomolecules and/or polymers on a surface of a single substrate for imaging, the method comprising:
robotically dispensing a liquid sample comprising biomolecules and/or polymers into a plurality of microwells on a wafer to form a thin liquid layer in each microwell;
simultaneously contacting each liquid layer in the plurality of microwells with the surface of the single substrate for a time sufficient to transfer a portion of each sample to the surface of the substrate such that the biomolecules and/or polymers adhere to the surface;
removing the surface from contact with the liquid layers with the biomolecules and/or polymers being immobilized on the surface of the substrate; and
optionally, drying, or rinsing and drying, the substrate in preparation for imaging.

13. The method of claim 12, wherein the plurality of microwells is arranged in an array on the wafer sufficiently separate from each other to avoid sample bleed over upon removal of the surface from contact with the liquid layer.

14. The method of claim 12, wherein dispensing is performed by an inkjet-type device or by a microfluidic device.

15. The method of claim 12, wherein the wafer comprises a semiconductor wafer or other-silicon based wafer, with or without a coating.

16. The method of claim 12, wherein the microwells are etched into the wafer.

17. The method of claim 12, wherein the substrate is selected from the group consisting of mica, gold, glass, quartz, graphite, silicon and plastic, and a surface thereof is treated or untreated.

18. The method of claim 12, wherein the biomolecules are selected from the group consisting of nucleic acids, proteins, protein-nucleic acid complexes, carbohydrates, polysaccharides, cellulose, synthetic polymers, cells, subcellular organelles, bacteria, and viruses.

19. The method of claim 12, wherein imaging comprises scanning probe microscopy (SPM), or SPM selected from the group consisting of atomic force microscopy (AFM), scanning tunneling microscopy (STM), near-field scanning optical microscopy (SNOM/NSOM), scanning electron microscopy and electrochemical AFM.

20. A stamp transfer apparatus comprising;
a base to support a wafer comprising one or more microwells;
an upper piston that can be moved vertically relative to the base and which comprises a headpiece positioned above the base and capable of being lowered to the base to contact a wafer on the base;
a headpiece for releasably holding an imaging substrate, and its optional backing, on the underside of the headpiece; and
a control to move the piston and bring the imaging substrate into and out of contact with the wafer.

21. The apparatus of claim 20, wherein headpiece is adapted to apply a vacuum through a port on the headpiece and thereby hold the substrate on an underside of the headpiece.
